(19) United States
(12) Patent Application Publication
(10) Pub. No.: US 2015/0070900 A1
(43) Pub. Date: Mar. 12, 2015

(54) CATADIOPTRIC SPOTLIGHT

(71) Applicant: 3M INNOVATIVE PROPERTIES COMPANY, St. Paul, MN (US)

(72) Inventors: Patrick R. Fleming, Lake Elmo, MN (US); Thomas R.J. Corrigan, St. Paul, MN (US); Lars A. Smeenk, St. Paul, MN (US); Thomas R. Hoffend, JR., Woodbury, MN (US)

(21) Appl. No.: 14/482,048

(22) Filed: Sep. 10, 2014

Related U.S. Application Data
(60) Provisional application No. 61/876,869, filed on Sep. 12, 2013.

(51) Int. Cl. G02B 17/08; F21K 99/00; F21V 13/04

(52) U.S. Cl. CPC G02B 17/08; F21V 13/04; F21K 9/58; F21Y 2101/02
USPC 362/308; 362/311.01; 362/311.02

(57) ABSTRACT

The present disclosure describes a compact spotlight that can change the area which it illuminates. The spotlight incorporates a wide angle light source, a catadioptric lens, and a bearing system for moving the catadioptric lens, the light source, or both. Movement of the light source relative to the catadioptric lens along the optical axis can change the beam diameter of the spotlight, while providing an acceptable illumination pattern.

### BACKGROUND

Several companies produce spotlight fixtures useful for theater lighting, with ellipsoidal reflectors that have zoom optics on them. Zoom optics can be used to change the area that the fixture illuminates. Typical spotlights have at least three optical elements: a reflector and two lenses. These fixtures can require large relative motions of the optical elements to do the zooming, and the fixtures are also large compared to their source elements.

Other zoom fixtures for illumination include flashlights that can have a small incandescent or light emitting diode (LED) source and use a parabolic reflector to collimate the beam into focused or expanded beams. In many cases, the source is moved relative to the reflector to change the size of the beam. However, this movement also can drastically change the shape of the beam, giving a donut shaped beam at wider beam angles.

### SUMMARY

The present disclosure describes a compact spotlight that can change the area which it illuminates. The spotlight incorporates a wide angle light source, a catadioptric lens, and a bearing system for moving the catadioptric lens, the light source, or both. Movement of the light source relative to the catadioptric lens along the optical axis can change the beam diameter of the spotlight while providing an acceptable illumination pattern. In one aspect, the present disclosure provides a spotlight that includes a catadioptric lens having an input aperture, an output aperture, an optical axis, and a catadioptric focal point on the optical axis; a light source positioned on the optical axis adjacent the input aperture, the light source in thermal contact with a support; and a focusing mechanism capable of changing a separation distance along the optical axis between the light source and the input aperture. The catadioptric lens can include a visible-light transparent material having an ellipsoidal refractive surface with an ellipsoidal focal point, a paraboloidal reflective surface with a paraboloidal focal point, and a conical refractive surface between the ellipsoidal refractive surface and the paraboloidal reflective surface. At least one of the ellipsoidal focal point and the paraboloidal focal point can be coincident with the catadioptric focal point, and the light source can be a light emitting diode (LED).

In another aspect, the present disclosure provides a spotlight that includes a catadioptric lens that includes an input aperture, an output aperture, an optical axis, and a catadioptric focal point on the optical axis at the input aperture. The catadioptric lens further includes an ellipsoidal refractive surface having an ellipsoidal focal point; a paraboloidal reflective surface having a paraboloidal focal point, at least one of the paraboloidal focal point, the ellipsoidal focal point and the catadioptric focal point being coincident; and a conical refractive surface between the ellipsoidal refractive surface and the paraboloidal reflective surface, the conical refractive surface having a first end adjacent the ellipsoidal refractive surface and an opposing second end adjacent the paraboloidal reflective surface. The spotlight further includes a light source positioned on the optical axis adjacent the input aperture, the light source in thermal contact with a support; and a flexure bearing between the support and the catadioptric lens, capable of changing a separation distance along the optical axis between the light source and the input aperture. The input aperture can include an input cavity extending interior to the catadioptric lens and capable of at least partially enclosing the light source, and light source can be an LED.

In yet another aspect, the present disclosure provides a method of changing spotlight illumination that includes positioning a spotlight to illuminate a region. The spotlight includes a catadioptric lens having an input aperture, an output aperture, an optical axis, and a catadioptric focal point on the optical axis; a light source positioned on the optical axis adjacent the input aperture, the light source in thermal contact with a support; and a focusing mechanism capable of changing a separation distance along the optical axis between the light source and the input aperture. The catadioptric lens can include a visible-light transparent material having an ellipsoidal refractive surface with an ellipsoidal focal point, a paraboloidal reflective surface with a paraboloidal focal point, and a conical refractive surface between the ellipsoidal refractive surface and the paraboloidal reflective surface. At least one of the ellipsoidal focal point and the paraboloidal focal point can be coincident with the catadioptric focal point, and the light source can be an LED. The method of changing spotlight illumination further includes changing the separation distance between the light source and the input aperture so that the light source moves relative to the catadioptric focal point thereby broadening or narrowing the illuminated region.

In yet another aspect, the present disclosure provides a method of changing spotlight illumination that includes positioning a spotlight to illuminate a region. The spotlight includes a catadioptric lens that includes an input aperture, an output aperture, an optical axis, and a catadioptric focal point on the optical axis at the input aperture. The catadioptric lens further includes an ellipsoidal refractive surface having an ellipsoidal focal point; a paraboloidal reflective surface having a paraboloidal focal point, at least one of the paraboloidal focal point, the ellipsoidal focal point and the catadioptric focal point being coincident; and a conical refractive surface between the ellipsoidal refractive surface and the paraboloidal reflective surface, the conical refractive surface having a first end adjacent the ellipsoidal refractive surface and an opposing second end adjacent the paraboloidal reflective surface. The spotlight further includes a light source positioned on the optical axis adjacent the input aperture, the light source in thermal contact with a support; and a flexure bearing between the support and the catadioptric lens, capable of changing a separation distance along the optical axis between the light source and the input aperture. The input aperture can include an input cavity extending interior to the catadioptric lens and capable of at least partially enclosing the light source, and light source can be an LED. The method of changing spotlight illumination further includes changing the separation distance between the light source and the input aperture so that the light source moves relative to the catadioptric focal point thereby broadening or narrowing the illuminated region.

The above summary is not intended to describe each disclosed embodiment or every implementation of the present disclosure. The figures and the detailed description below more particularly exemplify illustrative embodiments.

### BRIEF DESCRIPTION OF THE DRAWINGS

Throughout the specification reference is made to the appended drawings, where like reference numerals designate like elements, and wherein:

FIG. 1 shows a cross-sectional schematic view of a catadioptric lens;

FIG. 2 shows a cross-sectional schematic view of a catadioptric spotlight;

FIG. 3A shows a cross-sectional schematic view of a catadioptric spotlight;

FIG. 3B shows a cross-sectional schematic view of a catadioptric spotlight;

FIG. 3C shows a cross-sectional schematic view of a catadioptric spotlight;

FIG. 4 shows a perspective view of a flexure bearing;

FIG. 5 shows a plot of beam angle and peak height shift vs separation distance; and

FIG. 6 shows a plot of beam angle vs separation distance.

The figures are not necessarily to scale. Like numbers used in the figures refer to like components. However, it will be understood that the use of a number to refer to a component in a given figure is not intended to limit the component in another figure labeled with the same number.

### DETAILED DESCRIPTION

The present disclosure is directed to an improvement to conventional spotlight illumination systems used, for example, in retail displays, museums, galleries, churches, public lobbies and speaking venues. This type of architectural lighting is often referred to as display lighting. The invention described herein can also be used in theatrical lighting.

In one aspect, an illumination device such as a spotlight is described that can change the area which it illuminates. The illumination device incorporates a wide angle light source, a catadioptric lens, and a bearing system for moving the catadioptric lens, the light source, or both. In one particular embodiment, the bearing system can restrict the degrees of freedom of movement of the lens and or light source, and simple mechanical means are capable of providing the relative motion. Movement of the light source relative to the catadioptric lens along the optical axis, can change the beam diameter of the fixture while providing an acceptable illumination pattern.

The light source can be any light source, but the disclosure is most useful with light sources that include wide angle emission. In one case, the preferred light source is a single light emitting diode (LED). Other light sources that can be used include incandescent filaments and gas discharge lamps, including high intensity discharge lamps and radio frequency driven plasma lamps.

In the following description, reference is made to the accompanying drawings that forms a part hereof and in which are shown by way of illustration. It is to be understood that other embodiments are contemplated and may be made without departing from the scope or spirit of the present disclosure. The following detailed description, therefore, is not to be taken in a limiting sense.

All scientific and technical terms used herein have meanings commonly used in the art unless otherwise specified. The definitions provided herein are to facilitate understanding of certain terms used frequently herein and are not meant to limit the scope of the present disclosure.

Unless otherwise indicated, all numbers expressing feature sizes, amounts, and physical properties used in the specification and claims are to be understood as being modified in all instances by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

As used in this specification and the appended claims, the singular forms “a,” “an,” and “the” encompass embodiments having plural referents, unless the content clearly dictates otherwise. As used in this specification and the appended claims, the term “or” is generally employed in its sense including “and/or” unless the content clearly dictates otherwise.

Spatially related terms, including but not limited to, “lower,” “upper,” “beneath,” “below,” “above,” and “on top,” if used herein, are utilized for ease of description to describe spatial relationships of an element(s) to another. Such spatially related terms encompass different orientations of the device in use or operation in addition to the particular orientations depicted in the figures and described herein. For example, if an object depicted in the figures is turned over or flipped over, portions previously described as below or beneath other elements would then be above those other elements.

As used herein, when an element, component or layer for example is described as forming a “coincident interface” with, or being “on” “connected to,” “coupled with” or “in contact with” another element, component or layer, it can be directly on, directly connected to, directly coupled with, in direct contact with, or intervening elements, components or layers may be on, connected, coupled or in contact with the particular element, component or layer, for example. When an element, component or layer for example is referred to as being “directly on,” “directly connected to,” “directly coupled with,” or “directly in contact with” another element, there are no intervening elements, components or layers for example.

As used herein, “have”, “having”, “include”, “including”, “comprise”, “comprising” or the like are used in their open ended sense, and generally mean “including, but not limited to.” It will be understood that the terms “consisting of” and “consisting essentially of” are subsumed in the term “comprising,” and the like.

A catadioptric lens is an optical element that has a reflecting portion that redirects the light that is far off the optical axis, and a refracting portion that redirects the light that is close to the optical axis. Catadioptric lenses have been known for some time, and were used, for example, as the optical elements in light houses. The lens for the present invention can be a single piece lens, and it is preferably made of acrylic or other clear moldable polymer, however glass can also be used. Making good catadioptric lenses from glass can be difficult, because of the numerous facets and interior angles that can be required.

The described spotlight also includes a bearing system that allows movement of either the lens or the optical element (or both). The preferred bearing system is a flexure bearing, which can be ideal for small motions where a static force can be tolerated. In one particular embodiment, an actuator such as a cam mounted on either a stepper motor or manual knob can be used to provide the static force that can provide for the relative motion through the bearing, as described elsewhere. In some cases, a simple screw mounted on a motor or equipped with a manual knob can instead be used to provide for the relative motion. In some cases, the spotlight can be designed to provide good thermal conductivity between the LED and the outside of the fixture to better dissipate the heat generated by the LED.

An acceptable light field for a spotlight is one that has the brightest point near the center of the beam, and the intensity falls off monotonically toward the edges. The beam width can be defined as the distance between the points on the edges of the light field at which the light falls to half of its peak intensity (full width half maximum or FWHM). The field width can be defined as the distance between the points on the edges of the light field at which the light falls to one tenth of its peak intensity. The beam does not have to be round, and in many cases an elliptical or oblong light field can be preferred.

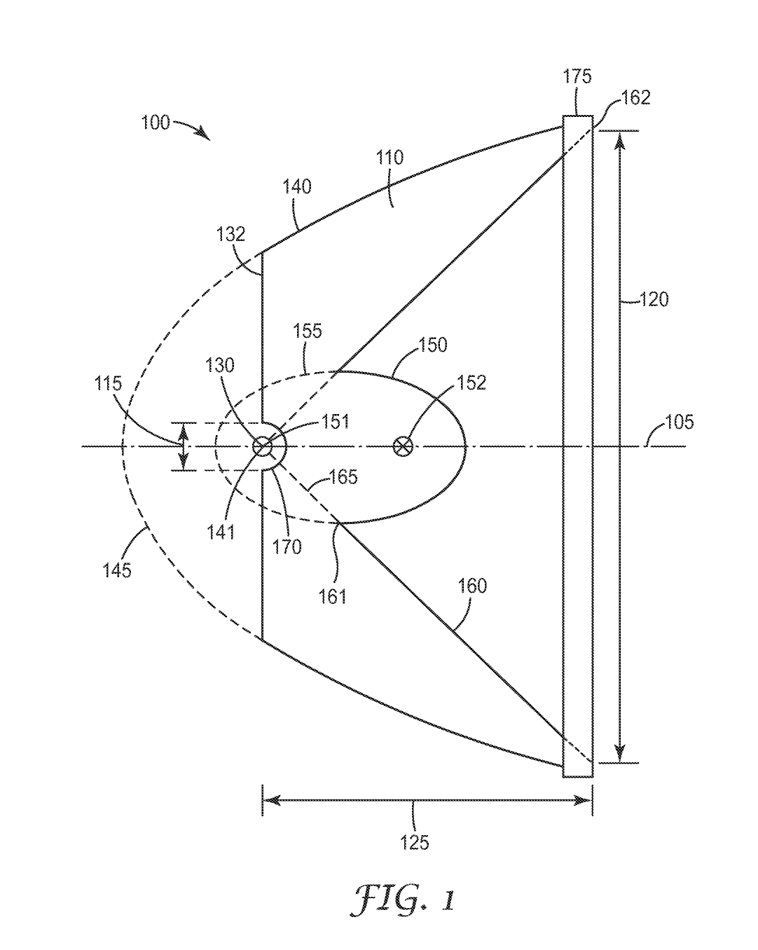

FIG. 1 shows a cross-sectional schematic view of a catadioptric lens 100, according to one aspect of the disclosure. Catadioptric lens 100 includes an input aperture 115, an output aperture 120 opposite the input aperture 115, an optical axis 105 and a catadioptric focal point 130 disposed on the optical axis 105. The catadioptric lens 100 can be fabricated from any visible-light transmissive material 110 including, for example, glasses or polymeric materials such as acrylics or polycarbonates. In some cases, the visible-light transmissive material 110 can have an index of refraction that ranges from about 1.3 to about 2, or from about 1.4 to about 1.7, or from about 1.4 to about 1.6; however, any desired index material can be used suitable for the optical design of the catadioptric lens, as described elsewhere.

A catadioptric optical system includes both refractive elements and reflective elements. In one particular embodiment, catadioptric lens 100 includes a paraboloidal reflective surface 140, an ellipsoidal refractive surface 150, and a conical refractive surface 160 between the ellipsoidal refractive surface 150 and the paraboloidal reflective surface 140. Conical refractive surface 160 can be the rotation surface generated by rotating a line 165 around optical axis 105.

In one particular embodiment, conical refractive surface 160 can have a vertex coincident with the catadioptric focal point 130, and have a base coincident with the output aperture 120.

Paraboloidal reflective surface 140 can be the rotation surface generated by rotating a parabola 145 around optical axis 105. Paraboloidal reflective surface 140 can be associated with a paraboloidal focal point 141, as known to one of skill in the art. In one particular embodiment shown in FIG. 1, the paraboloidal focal point 141 is positioned coincident with the catadioptric focal point 130. In some cases, the paraboloidal reflective surface 140 can be made reflective by deposition of a metal, a metal alloy, or an organic or inorganic multilayer interference stack. In one particular embodiment, the paraboloidal reflective surface 140 can be a polished surface such that Total Internal Reflection (TIR) can occur at the interface between the paraboloidal reflective surface 140 and the surrounding medium, generally air, as known to one of skill in the art. TIR can be a preferred over other reflective surface preparations.

Ellipsoidal refractive surface 150 can be the rotation surface generated by rotating an ellipse 155 around optical axis 105. Ellipsoidal refractive surface 150 can be specified by an ellipsoidal focal point 151 and a second focal point 152, as known to one of skill in the art. In one particular embodiment shown in FIG. 1, the ellipsoidal focal point 151 is positioned coincident with the catadioptric focal point 130. In some cases, the conical refractive surface 160 can intersect the ellipsoidal refractive surface 150 at a first end l6lsuch that the ellipse 155 is split in the middle between the ellipsoidal focal point 151 and the second focal point 152, although this can be optional.

The catadioptric lens 100 further includes an input plane 132 that includes the input aperture 115, a depth 125 between the input aperture 115 and the output aperture 120. In some cases, an optional reinforcing rim 175 can be formed at the intersection of the conical refractive surface 160 second end 162 and the paraboloidal reflective surface 140, to strengthen and stabilize the catadioptric lens 100. An input cavity 170 can be formed in the catadioptric lens 100 to accommodate the motion of a light source (not shown) across the input plane 132 either toward the output aperture 120 or away from the output aperture 120, as described elsewhere.

It is to be understood that although the present disclosure is directed toward catadioptric lenses having ellipsoidal surfaces, paraboloidal surfaces, and conical surfaces, each of these surfaces can instead be approximated by stepwise facets, such as Fresnel steps, as known to one of skill in the art. In some cases, these planar or curved facets can approximate each of the complex curvature surfaces, to produce acceptable spotlight illumination patterns.

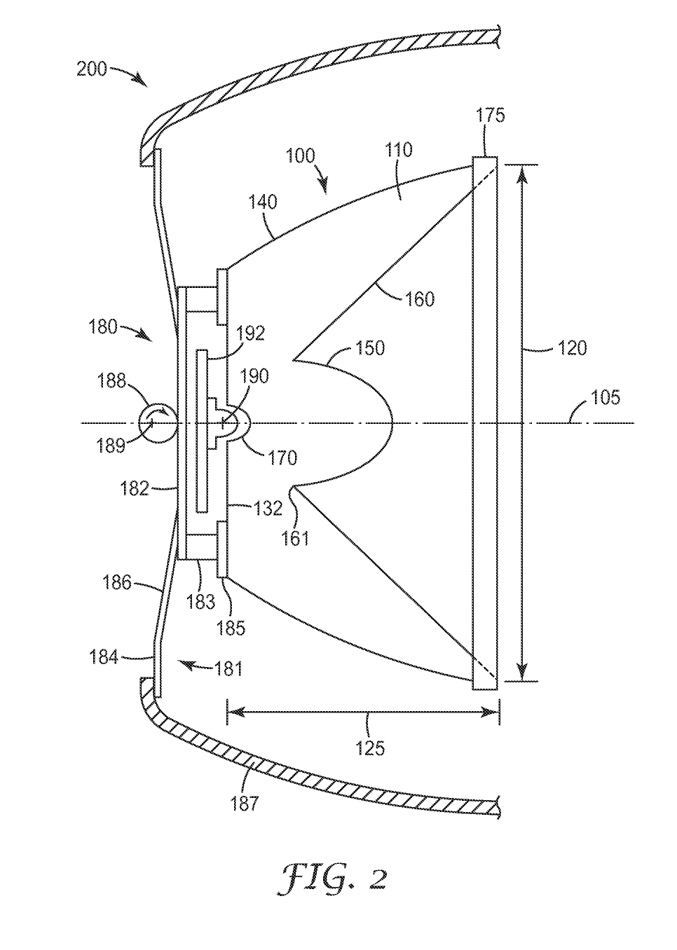

FIG. 2 shows a cross-sectional schematic view of a catadioptric spotlight 200, according to one aspect of the disclosure. Each of the elements 100-170 shown in FIG. 2 correspond to like-numbered elements already described with reference to FIG. 1. For example, catadioptric focal point 130 of FIG. 2 corresponds to catadioptric focal point 130 of FIG. 1, and so on. Catadioptric spotlight 100 includes a catadioptric lens 100 includes a paraboloidal reflective surface 140, an ellipsoidal refractive surface 150, and a conical refractive surface 160 between the ellipsoidal refractive surface 150 and the paraboloidal reflective surface 140. The conical refractive surface 160 has a first end 161 at the intersection with the ellipsoidal refractive surface 160, and a second end 162 having an optional reinforcing rim 175 at the intersection with the paraboloidal reflective surface 140.

Catadioptric spotlight 200 further includes a light source 190 positioned on the optical axis 105 adjacent the input aperture (input aperture 115, shown in FIG. 1). The light source 190 can be in thermal contact with a support 192 so that heat generated during operation of the light source 190 can be dissipated. Catadioptric spotlight 200 further includes a focusing mechanism 180 capable of changing a separation distance along the optical axis 105, between the light source 190 and the input aperture 115, such that the light source 190 can move across the input plane 132. In some cases, the light source 190 can enter and leave the input cavity 170 that extends interior to the catadioptric lens 100 and can at least partially enclose light source 190.

In one particular embodiment, the focusing mechanism 180 can be a flexure bearing 181 having an inner portion 182, and outer portion 184, and a transition portion 186. Flexure bearings are well known mechanical devices that can be used create a small accurate linear translation of the inner portion 182 relative to the outer portion 184. In some cases, a cam 188 that rotates around an axis 189 can be used to effect the small linear translations of the inner portion 182 relative to the outer portion 184. In some cases, a threaded rod (not shown), a solenoid (also not shown), or other known device, can be used to effect the small linear translations. In some cases, the cam, threaded rod, solenoid, or other device can be manually operated, or may be operated by a motor or other electronic device, as known to one of skill in the art.

The focusing mechanism 180 can be used to move the light source 190, the catadioptric lens 100, or both. In one particular embodiment, shown in FIG. 2, the inner portion 182 can be affixed to the catadioptric lens 100 by an appropriate spacer 183 and bond 185. A housing 187 can be affixed to the outer portion 184 of the flexure bearing 181, and the light source 190 and support 192 can also be affixed to the housing 187 such that relative motion can occur between the light source 190 and catadioptric lens 100 along the optical axis 105, by movement of the catadioptric lens 100 within the housing 187. It is to be understood that the catadioptric lens 100 could instead be affixed to the housing 187, and the light source 190 and support 192 could be affixed to the inner portion 182 of the flexure bearing 181, with similar results.

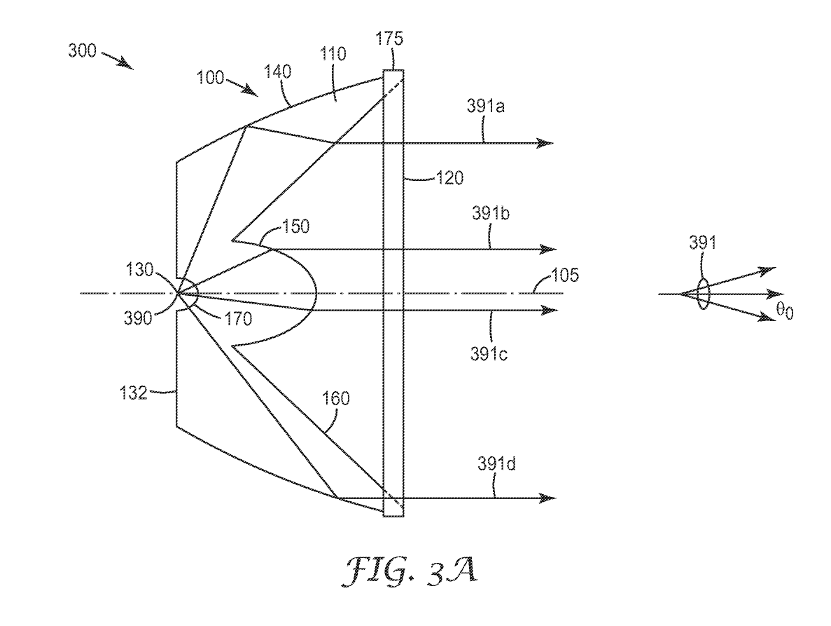

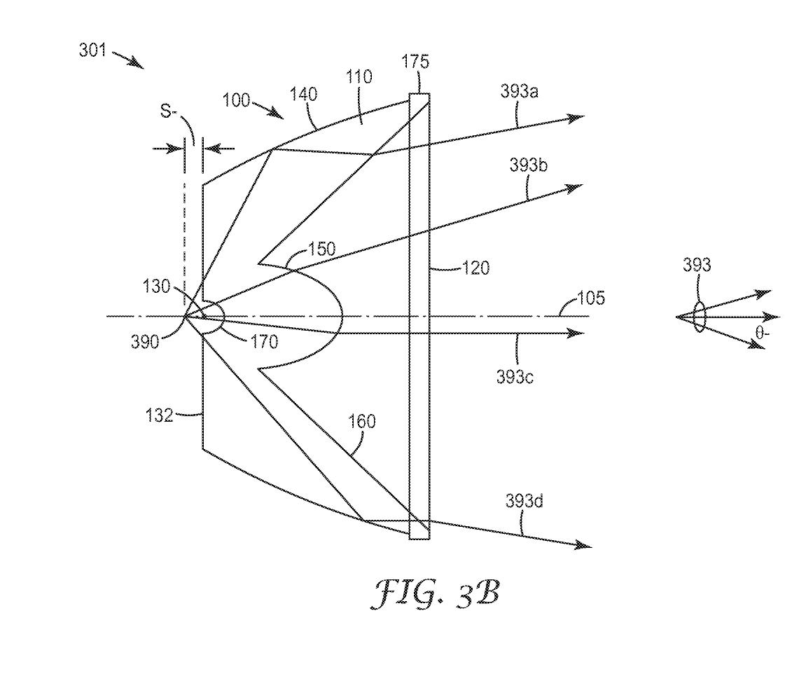

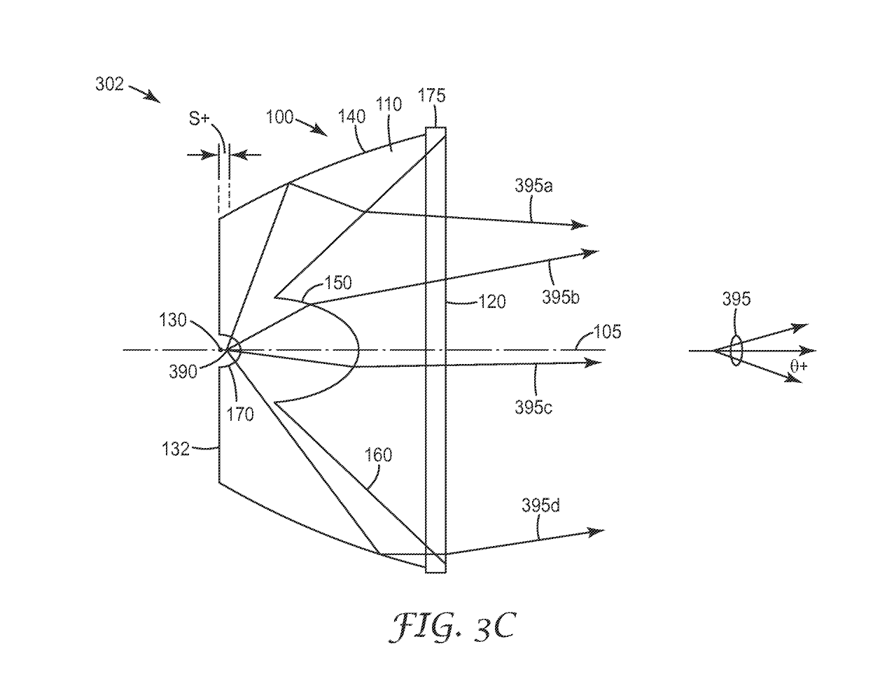

FIG. 3A shows a cross-sectional schematic view of a catadioptric spotlight 300 showing representative light ray paths for a well collimated (i.e., focused) beam, according to one aspect of the disclosure. Each of the elements 100-170 shown in FIG. 3A correspond to like-numbered elements already described with reference to FIG. 1. For example, catadioptric focal point 130 of FIG. 3A corresponds to catadioptric focal point 130 of FIG. 1, and so on. In FIG. 3A, light source 390 is shown to be coincident with catadioptric focal point 130. Each of the elements shown in FIG. 2 other than catadioptric lens 100 have been removed from FIG. 3A for clarity;

however, it is to be understood that focusing mechanisms have been used for the specific placement of light source 390 and catadioptric focal point 130 shown.

A focused beam 391 having a focused beam angle θ₀ results from a first through a fourth light ray 391a, 391b, 391c, 391d, emanating from light source 390 that is positioned coincident with catadioptric focal point 130. First and fourth light ray 391a, 391d, pass through visible-light transmissive material 100, reflect from paraboloidal reflective surface 140, refract passing through conical refractive surface 160, and leave output aperture 120 within focused beam angle θ₀. Second and third light ray 391b, 391c, pass through visible-light transmissive material 100, refract passing through ellipsoidal refractive surface 150, and leave output aperture 120 within focused beam angle θ₀. Each of the first through a fourth light rays 391a, 391b, 391c, 391d exit the output aperture 120 in a direction that is very nearly parallel to the optical axis 105, and the resulting focused beam angle θ₀ is minimized.

FIG. 3B shows a cross-sectional schematic view of a catadioptric spotlight 301 showing representative light ray paths for a de-collimated (i.e., spread) beam, according to one aspect of the disclosure. Each of the elements 100-170 shown in FIG. 3B correspond to like-numbered elements already described with reference to FIG. 1. For example, catadioptric focal point 130 of FIG. 3B corresponds to catadioptric focal point 130 of FIG. 1, and so on. In FIG. 3B, light source 390 is shown to be displaced at a negative separation distance “S−” from the catadioptric focal point 130 (as used herein, a negative distance is the relative motion of the light source 390 away from the output aperture 120). Each of the elements shown in FIG. 2 other than catadioptric lens 100 have been removed from FIG. 3B for clarity; however, it is to be understood that focusing mechanisms have been used for the specific placement of light source 390 and catadioptric focal point 130 shown.

A negative defocused beam 393 having a negative defocused beam angle θ− results from a first through a fourth negative light ray 393a, 393b, 393c, 393d, emanating from light source 390 that is positioned at a negative separation distance “S−” from catadioptric focal point 130.

First and fourth negative light ray 393a, 393d, pass through visible-light transmissive material 100, reflect from paraboloidal reflective surface 140, refract passing through conical refractive surface 160, and leave output aperture 120 within negative defocused beam angle θ−. Second and third negative light ray 393b, 393c, pass through visible-light transmissive material 100, refract passing through ellipsoidal refractive surface 150, and leave output aperture 120 within negative defocused beam angle θ−. Each of the first through a fourth negative light rays 393a, 393b, 393c, 393d exit the output aperture 120 in a direction that is at an angle to the optical axis 105.

FIG. 3C shows a cross-sectional schematic view of a catadioptric spotlight 302 showing representative light ray paths for a de-collimated (i.e., spread) beam, according to one aspect of the disclosure. Each of the elements 100-170 shown in FIG. 3C correspond to like-numbered elements already described with reference to FIG. 1. For example, catadioptric focal point 130 of FIG. 3C corresponds to catadioptric focal point 130 of FIG. 1, and so on. In FIG. 3C, light source 390 is shown to be displaced at a positive separation distance “S+” from the catadioptric focal point 130, i.e., within the light source cavity 170. Each of the elements shown in FIG. 2 other than catadioptric lens 100 have been removed from FIG. 3C for clarity; however, it is to be understood that focusing mechanisms have been used for the specific placement of light source 390 and catadioptric focal point 130 shown.

A positive defocused beam 395 having a positive defocused beam angle θ+ results from a first through a fourth positive light ray 395a, 395b, 395c, 395d, emanating from light source 390 that is positioned at a positive separation distance “S+” from catadioptric focal point 130. First and fourth positive light ray 395a, 395d, pass through visible-light transmissive material 100, reflect from paraboloidal reflective surface 140, refract passing through conical refractive surface 160, and leave output aperture 120 within positive defocused beam angle θ+. Second and third positive light ray 395b, 395c, pass through visible-light transmissive material 100, refract passing through ellipsoidal refractive surface 150, and leave output aperture 120 within positive defocused beam angle θ+. Each of the first through a fourth positive light rays 395a, 395b, 395c, 395d exit the output aperture 120 in a direction that is at an angle to the optical axis 105.

FIG. 4 shows a perspective view of a flexure bearing 480, according to one aspect of the disclosure. In one particular embodiment, flexure bearing 480 can be used to effect the small precise linear motion that can be used to change the distance between the light source 390 and the catadioptric focal point 130 as shown in FIGS. 3A-3C. Flexure bearing 480 can be formed from a thin circular sheet (c.a., 0.020 inch or 0.508 mm thick) of metal, including but not limited to copper and aluminum, or metal alloy, for example steel, stainless steel, nickel, and the like. Circular slots of different radii can be cut or stamped in the thin circular sheet such that upon application of a force between an inner portion 482 and an outer portion 484, a transition region 486 deforms to provide relative linear motion between the inner and outer portions 482, 484, as shown in FIG. 4. In one particular embodiment, the flexure bearing 480 can have circular slots having a slot width of 0.050 inches (1.27 mm) with an inner radius of 1.1 inches (27.94 mm), an outer radius of 1.650 inches (41.91 mm), and a middle radius of 1.400 inches (35.56 mm).

### EXAMPLES

### Example 1

A model of a catadioptric lens and an LED was built in optical modeling software (Trace Pro, available from Lambda Research, Littleton MA). The lens had a 50 mm diameter output area, and measured 22 mm from the back plane to the front plane. The outer surface between the back plane and the front plane was a rotated parabolic surface to form the reflective paraboloidal surface portion of the catadioptric lens. The center part of the front surface was a half an ellipse having a minor axis of 6 mm and a major axis of 8.09 mm, rotated to form the ellipsoidal refractive surface. A conical refractive surface was created from the intersection of the half and ellipse to the reflective paraboloid at the output surface, as shown in FIGS. 1-3C. The LED was positioned in a 6 mm diameter hemispheric cavity cut into the back surface of the lens. The center of the hemisphere, one focal point of the ellipse, the focal point of the parabola, and the initial position of the LED were all coincident. The refractive index of the optic was set to be 1.491, the refractive index of an acrylic polymer material.

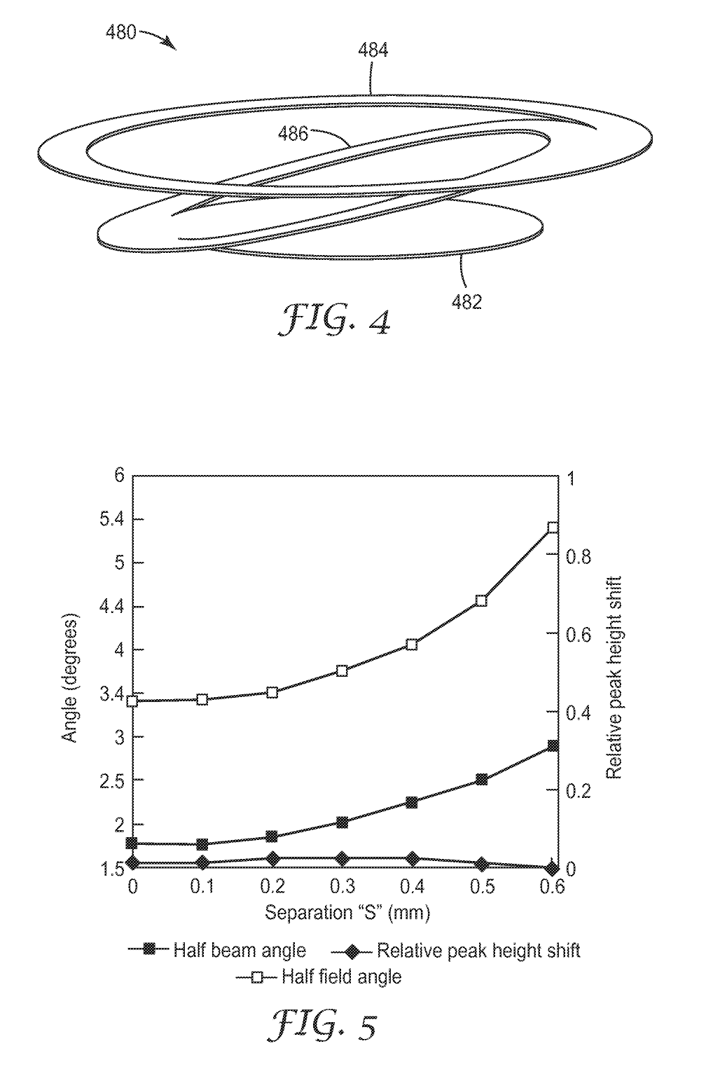

The lens was designed such that the optimal position (smallest beam width) was with the emitting face of the LED flush with the back surface of the lens. In this position, the beam width was approximately 3.5° (full width). As the LED was moved into the optic, the beam became wider. At 0.6 mm, the beam was approximately 5.8° wide. The beam became even wider when the LED was positioned further inside the optic, but an undesirable dip in beam intensity developed in the center of the beam, and would be perceived as a dark spot. So, for this design, which was not optimized as a variable beam width element, the simulation showed a 1.65× zoom capability by pushing the LED deeper into the optic. FIG. 5 shows a plot of beam angle and peak height shift vs separation distance for the system simulated in Example 1.

### Example 2

A catadioptric lens similar to that in Example 1 was constructed out of acrylic. The lens had a 50 mm diameter output region and measured 21.5 mm from the back plane to the front plane. The cavity that accepted the LED was a hemisphere that was 4.75 mm in diameter. The surface of the cavity could not be easily polished, so an index matching fluid was used to provide coupling between the LED and the optic.

The lens was mounted on a precision optical stage, on which the relative movement of the LED and optic could be measured and controlled. The LED was illuminated and the light from the system was directed at a screen 3.5 meters away. An industrial camera (Lumenera Lu165, available from Lumenera Corp, Ottawa, Canada) was used to photograph the light pattern on the screen. The size and shape of the light field was then analyzed.

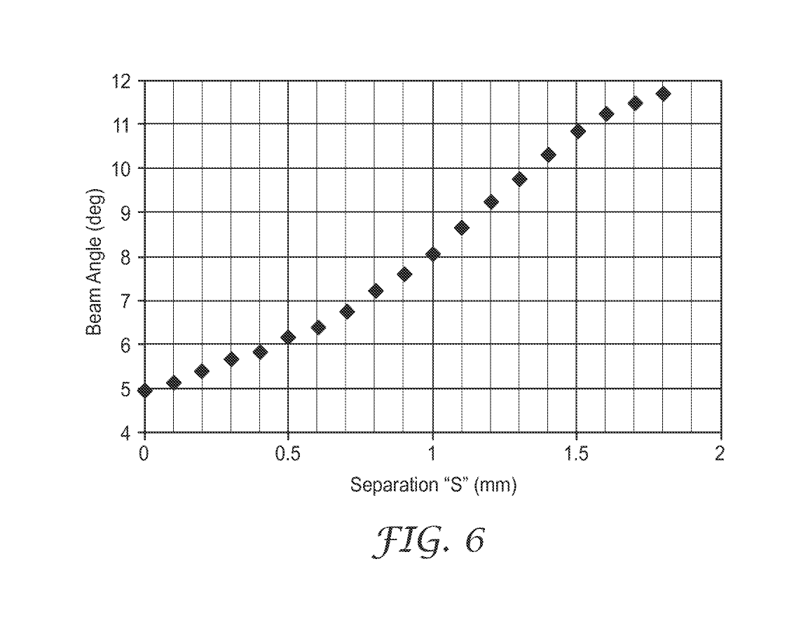

When the LED was positioned as far into the optic as possible, the beam showed an approximately 5° beam angle. As the LED was drawn out of the optic the beam spread gradually until it was approximately 11° when the LED had been moved 1.5 mm. The beam maintained a desirable pattern with the peak intensity at the center and a monotonic decrease toward the edge over this range. FIG. 6 shows a plot of beam angle vs separation distance between the light source and the catadioptric focal point, for Example 2.

Following are a list of embodiments of the present disclosure.

Item 1 is a spotlight, comprising: a catadioptric lens having an input aperture, an output aperture, an optical axis, and a catadioptric focal point on the optical axis; a light source positioned on the optical axis adjacent the input aperture, the light source in thermal contact with a support; and a focusing mechanism capable of changing a separation distance along the optical axis between the light source and the input aperture.

Item 2 is the spotlight of item 1, wherein the catadioptric lens comprises a visible-light transparent material having an ellipsoidal refractive surface with an ellipsoidal focal point, a paraboloidal reflective surface with a paraboloidal focal point, and a conical refractive surface between the ellipsoidal refractive surface and the paraboloidal reflective surface.

Item 3 is the spotlight of item 2, wherein at least one of the ellipsoidal focal point and the paraboloidal focal point is coincident with the catadioptric focal point.

Item 4 is the spotlight of item 1 to item 3, wherein the input aperture includes an input cavity extending interior to the catadioptric lens and capable of at least partially enclosing the light source.

Item 5 is the spotlight of item 4, wherein the light source is capable of being positioned within the input cavity or exterior to the input cavity.

Item 6 is the spotlight of item 1 to item 5, wherein the catadioptric focal point is positioned at the input aperture.

Item 7 is the spotlight of item 1 to item 6, wherein the focusing mechanism comprises a bearing having an interior portion and an exterior portion, the interior portion and exterior portion capable of relative motion along the optical axis.

Item 8 is the spotlight of item 7, wherein the bearing comprises a flexure bearing having at least one transition portion between the interior portion and the exterior portion.

Item 9 is the spotlight of item 1 to item 8, wherein the focusing mechanism comprises a threaded rod, a lever, a cam, or a combination thereof.

Item 10 is the spotlight of item 1 to item 9, wherein the focusing mechanism comprises manual operation, a solenoid, a motor, a stepper motor, or a combination thereof.

Item 11 is the spotlight of item 7 to item 10, wherein the interior portion is affixed to the light source support or the catadioptric lens.

Item 12 is the spotlight of item 7 to item 11, wherein the exterior portion is affixed to the light source support or the catadioptric lens.

Item 13 is the spotlight of item 1 to item 12, wherein the light source comprises a light emitting diode (LED).

Item 14 is the spotlight of item 1 to item 13, wherein the catadioptric lens comprises a polymeric material or a glass.

Item 15 is the spotlight of item 2 to item 14, wherein a first end of the conical refractive surface is adjacent the ellipsoidal refractive surface, and an opposing second end of the conical refractive surface is adjacent both the paraboloidal reflective surface and the output surface.

Item 16 is the spotlight of item 15, wherein the first end of the conical refractive surface intersects the ellipsoidal refractive surface.

Item 17 is a spotlight, comprising: a catadioptric lens, comprising: an input aperture, an output aperture, an optical axis, and a catadioptric focal point on the optical axis at the input aperture; an ellipsoidal refractive surface having an ellipsoidal focal point; a paraboloidal reflective surface having a paraboloidal focal point, at least one of the paraboloidal focal point, the ellipsoidal focal point and the catadioptric focal point being coincident; a conical refractive surface between the ellipsoidal refractive surface and the paraboloidal reflective surface, the conical refractive surface having a first end adjacent the ellipsoidal refractive surface and an opposing second end adjacent the paraboloidal reflective surface; a light source positioned on the optical axis adjacent the input aperture, the light source in thermal contact with a support; and a flexure bearing between the support and the catadioptric lens, capable of changing a separation distance along the optical axis between the light source and the input aperture.

Item 18 is the spotlight of item 17, wherein the input aperture includes an input cavity extending interior to the catadioptric lens and capable of at least partially enclosing the light source.

Item 19 is the spotlight of item 17 or item 18, wherein the light source comprises an LED.

Item 20 is a method of changing spotlight illumination, comprising: positioning the spotlight of item 1 to item 18 to illuminate a region; and changing the separation distance between the light source and the input aperture so that the light source moves relative to the catadioptric focal point thereby broadening or narrowing the illuminated region.

Unless otherwise indicated, all numbers expressing feature sizes, amounts, and physical properties used in the specification and claims are to be understood as being modified by the term “about.” Accordingly, unless indicated to the contrary, the numerical parameters set forth in the foregoing specification and attached claims are approximations that can vary depending upon the desired properties sought to be obtained by those skilled in the art utilizing the teachings disclosed herein.

All references and publications cited herein are expressly incorporated herein by reference in their entirety into this disclosure, except to the extent they may directly contradict this disclosure. Although specific embodiments have been illustrated and described herein, it will be appreciated by those of ordinary skill in the art that a variety of alternate and/or equivalent implementations can be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A spotlight, comprising:
a catadioptric lens having an input aperture, an output aperture, an optical axis, and a catadioptric focal point on the optical axis;
a light source positioned on the optical axis adjacent the input aperture, the light source in thermal contact with a support; and
a focusing mechanism capable of changing a separation distance along the optical axis between the light source and the input aperture.

2. The spotlight of claim 1, wherein the catadioptric lens comprises a visible-light transparent material having an ellipsoidal refractive surface with an ellipsoidal focal point, a paraboloidal reflective surface with a paraboloidal focal point, and a conical refractive surface between the ellipsoidal refractive surface and the paraboloidal reflective surface.

3. The spotlight of claim 2, wherein at least one of the ellipsoidal focal point and the paraboloidal focal point is coincident with the catadioptric focal point.

4. The spotlight of claim 1, wherein the input aperture includes an input cavity extending interior to the catadioptric lens and capable of at least partially enclosing the light source.

5. The spotlight of claim 4, wherein the light source is capable of being positioned within the input cavity or exterior to the input cavity.

6. The spotlight of claim 1, wherein the catadioptric focal point is positioned at the input aperture.

7. The spotlight of claim 1, wherein the focusing mechanism comprises a bearing having an interior portion and an exterior portion, the interior portion and exterior portion capable of relative motion along the optical axis.

8. The spotlight of claim 7, wherein the bearing comprises a flexure bearing having at least one transition portion between the interior portion and the exterior portion.

9. The spotlight of claim 1, wherein the focusing mechanism comprises a threaded rod, a lever, a cam, or a combination thereof.

10. The spotlight of claim 1, wherein the focusing mechanism comprises manual operation, a solenoid, a motor, a stepper motor, or a combination thereof

11. The spotlight of claim 7, wherein the interior portion is affixed to the light source support or the catadioptric lens.

12. The spotlight of claim 7, wherein the exterior portion is affixed to the light source support or the catadioptric lens.

13. The spotlight of claim 1, wherein the light source comprises a light emitting diode (LED).

14. The spotlight of claim 1, wherein the catadioptric lens comprises a polymeric material or a glass.

15. The spotlight of claim 2, wherein a first end of the conical refractive surface is adjacent the ellipsoidal refractive surface, and an opposing second end of the conical refractive surface is adjacent both the paraboloidal reflective surface and the output surface.

16. The spotlight of claim 15, wherein the first end of the conical refractive surface intersects the ellipsoidal refractive surface.

17. A spotlight, comprising:
a catadioptric lens, comprising:
an input aperture, an output aperture, an optical axis, and a catadioptric focal point on the optical axis at the input aperture;
an ellipsoidal refractive surface having an ellipsoidal focal point;
a paraboloidal reflective surface having a paraboloidal focal point, at least one of the paraboloidal focal point, the ellipsoidal focal point and the catadioptric focal point being coincident;
a conical refractive surface between the ellipsoidal refractive surface and the paraboloidal reflective surface, the conical refractive surface having a first end adjacent the ellipsoidal refractive surface and an opposing second end adjacent the paraboloidal reflective surface;
a light source positioned on the optical axis adjacent the input aperture, the light source in thermal contact with a support; and
a flexure bearing between the support and the catadioptric lens, capable of changing a separation distance along the optical axis between the light source and the input aperture.

18. The spotlight of claim 17, wherein the input aperture includes an input cavity extending interior to the catadioptric lens and capable of at least partially enclosing the light source.

19. The spotlight of claim 17, wherein the light source comprises an LED.

20. A method of changing spotlight illumination, comprising:
positioning the spotlight of claim 1 to illuminate a region; and
changing the separation distance between the light source and the input aperture so that the light source moves relative to the catadioptric focal point thereby broadening or narrowing the illuminated region.

21. A method of changing spotlight illumination, comprising:
positioning the spotlight of claim 17 to illuminate a region; and
changing the separation distance between the light source and the input aperture so that the light source moves relative to the catadioptric focal point thereby broadening or narrowing the illuminated region.
